(19) United States
(12) Patent Application Publication
(10) Pub. No.: US 2023/0136991 A1
(43) Pub. Date: May 4, 2023

(54) ITURIN FAMILY LIPOPEPTIDES IN PEST CONTROL

(71) Applicant: Institute of Biology, Hebei Academy of Sciences, Shijiazhuang (CN)

(72) Inventors: Hongwei LIU, Shijiazhuang (CN); Liping ZHANG, Shijiazhuang (CN); Yongfeng LIU, Shijiazhuang (CN); Caimiao YAO, Shijiazhuang (CN); Wenya ZHAO, Shijiazhuang (CN); Yujia ZHENG, Shijiazhuang (CN)

(21) Appl. No.: 18/146,171

(22) Filed: Dec. 23, 2022

Related U.S. Application Data
(63) Continuation of application No. PCT/CN22/85344, filed on Apr. 6, 2022.

(30) Foreign Application Priority Data
Apr. 25, 2021 (CN) 202110445504.4

(51) Int. Cl. A01N 63/22

(52) U.S. Cl. CPC A01N 63/22

(57) ABSTRACT

An iturin family lipopeptides are provide for pest control, including insecticidal activity against Homoptera insects and Coleoptera insects. The iturin may be applied to seeds, plants or soil for control of agricultural pests.

### CROSS-REFERENCE TO RELATED APPLICATIONS

This application claims priority to Chinese Patent Application No. 202110445504.4, filed on Apr. 25, 2021, the contents of which are hereby incorporated by reference as if fully rewritten herein.

### TECHNICAL FIELD

The application relates generally to the technical field of pest control, and in particular to an application of iturin family lipopeptides in pest control.

### BACKGROUND

Iturin family compounds were separated from Bacillus subtilis by Delcambe and Devignat in 1957. So far, many lipopeptides belonging to iturin family have been found, such as Iturin A, B, C, D, E, bacillomycin D, F, L and mycosporin. Recently, it has been found that Paenibacillus elgii, Bacillus amyloliquefaciens and Bacillus pumilus also produce iturin family lipopeptides. Iturin family compounds are linked by cyclo-heptapeptide and β-amino fatty acid chain with 14 to 17 carbons in length. Although the iturin family lipopeptides also have strong hemolysis, their biological activities are different from surfactants. Iturin family lipopeptides have strong in vitro resistance to a variety of yeasts and fungi, but have weak activity against bacteria and no antiviral activity. Comparing the different structures and functions of various lipopeptides of iturin family, it is found that the position and length of free carboxyl groups have an effect on their biological activity, and the antibacterial activity of the active substance becomes stronger with the increase of carbon atom number of the β-amino fatty acid chain.

Pest control is a very important part of agricultural production. With the change of agricultural production mode and the progress of science and technology, pest control strategies have successively gone through agricultural control, chemical control, comprehensive control and green control. With the continuous development of various pest control technologies, such as monitoring and early warning technology, precise pesticide application technology, biological control, physical control and transgenic technology, an integrated control technology system, which takes single crop production process and major disaster induced insects as the object, has been constructed successively, and played a key role in ensuring China's grain output and food safety and promoting ecological control of agricultural pests. In recent years, influenced by many factors, such as global climate change, change of farming mode, adjustment of industrial structure and increasing frequency of biological invasion brought by international trade exchange, the occurrence species and damage rules of agricultural pests in China have also changed obviously, and the agricultural pest control is facing new challenges.

Chemical control is widely adopted at present, but the problems of pesticide residues and biological resistance caused by long-term use of chemical pesticides have become increasingly prominent. In recent years, with people's growing concern for environmental ecology and food safety, it has been an inevitable trend to develop eco-friendly new pesticides. Iturin family lipopeptides are suitable for developing as new pest control drugs due to their broad antifungal spectrum, low toxicity, easy biodegradation, no allergic reaction and many other advantages.

### SUMMARY

The objective of the present application is to provide an application of iturin family lipopeptides in pest control, so as to solve the problems existing in the prior art mentioned above.

To achieve the above objective, the present application provides theapplication of iturin family lipopeptides as active ingredients in pest control.

Optionally, the iturin family lipopeptides are one of or a mixture of two or more of iturin A, iturin B, iturin C, iturin D, iturin E,bacillomycin D, bacillomycin F, bacillomycin L and mycosubtilin.

Optionally, the pests are Homoptera insects or Coleoptera insects.

Optionally, the HOMOPTERA insects are one or more of Aphis craccivora Koch, Aphis gossypii, Brevicoryne brassicae and Macrosiphum avenae.

Optionally, the Coleoptera insects are one or more of Protaetia brevitarsis, Holotrichia parallela, Anomala corpulenta and Polyphylla gracilicornis.

Optionally, the application is to prepare the iturin family lipopeptides into liquid and then treat plants or soil to control pests.

The present application also provides a method for protecting seeds and later formed plant organs from pests, including treating seeds with the iturin family lipopeptides.

Optionally, the mass concentration of the iturin family lipopeptides is 0.01-100 μg/mL

Optionally, the seeds are coated with a coating agent containing the iturin family lipopeptides.

Optionally, the coating agent further includes a film forming agent or an adhesive.

The present application discloses a new application of iturin in pest control. Experiments have proven that iturin has obvious insecticidal activity against Homoptera insects and Coleoptera insects, and its insecticidal effect may reach more than 90% in 24 hours, so iturin may be applied to the control of agricultural pests.

### DETAILED DESCRIPTION OF THE EMBODIMENTS

The technical solutions in the embodiments of the present application will be clearly and completely described below. Obviously, the described embodiments are only part of the embodiments of the present application, but not all of them. Based on the embodiments of the present application, all other embodiments obtained by ordinary technicians in the field without creative labor are within the scope of the present application.

In order to make the above objects, features and advantages of the present application more obvious and understandable, the present application will be further explained in detail with reference to the specific embodiments.

Unless otherwise specified, materials used in the embodiments may be obtained from commercial sources; The experimental methods used in the embodiments are conventional experimental methods in the field unless otherwise specified.

### Embodiment 1 Preparation of Iturins

Preparation of iturin family popeptides from Bacillus amyloliquefaciens

S1, carrying out amplification culture on the Bacillus amyloliquefaciens WS-8 (preservation number: CGMCC No.11787) to obtain fermentation liquor;

S2, centrifuging the fermentation liquor to remove thallus and then obtain sterile supernatant;

S3, adding amberlity XAD-7HP macroporous resin to the sterile supernatant for adsorption, and shaking at 4° C. for 12 hours;

S4, filtrating and collecting the resin, washing the resin with distilled water for three times, then with 60% ethanol (volume/volume), and concentrating the eluent to obtain a crude extract;

S5, using high performance liquid chromatography for further purification, including, loading mobile phase A, which is acetonitrile containing 0.1% (volume ratio) trifluoroacetic acid, and mobile phase B, which is ultrapure water containing 0.1% (volume ratio) trifluoroacetic acid, into WondaSil C18(4.6 mm×150 mm) chromatographic column with a particle size of 5 μm, using 10%-90% acetonitrile for linear gradient elution with the flow rate 1 mL/min, detecting the wavelength as 214 nm and the column temperature as 30° C., collecting the components corresponding to 30-50 min, and using the mass spectrometry (Table 1) to confirm that iturins are obtained.

TABLE 1
Mass spectrometry detection results of purified products

| Compound | | | |
|---|---|---|---|
| serial | m/z | m/z | Determination |
| number | [M + H]⁺ | [M + Na]⁺ | result |
| 1 | 1043.5474 | 1065.5284 | C₁₄Iturin A |
| 2 | 1044.5328 | 1066.5145 | C₁₄Iturin B |
| 3 | 1044.5334 | 1066.5149 | C₁₄Iturin B |
| 4 | 1057.5643 | 1079.5454 | C₁₅Iturin A |
| 5 | 1057.5636 | 1079.5449 | C₁₅Iturin A |

### Embodiment 2

Insecticidal Effect of the Iturins on HOMOPTERA Insects

Dissolving the iturins prepared in embodiment 1 in methanol to prepare 200 μg/mL mother liquor, and then diluting the mother liquor with water to 5 μg/mL, 10 μg/mL and 20 μg/mL liquid medicine, and using clean water treatment as a control; soaking young broad bean stems in insecticidal experiment of Aphis craccivora Koch, young cotton stems in insecticidal experiment of Aphis gossypii, young cabbage leaves in insecticidal experiment of Brevicoryne brassicae, young stems of wheat in insecticidal experiment of Macrosiphum avenae, soaking the young broad bean stems, the young cotton stems, the young cabbage leaves and the young stems of wheat in the above-mentioned liquid medicine for 10 minutes, then absorbing water with filter paper, taking them out, putting them in a plate with filter paper, adding 2 mL of deionized water to keep moisture, then covering the plate with fresh-keeping film, puncturing holes, and adding 1 mL of water every 12 hours; testing 50 aphids in each concentration respectively, repeating for 3 times, using a brush head to pick 50 aphids of each species with similar age and size, putting them on the plate to starve for 4 hours, then adding the young broad bean stems, the young cotton stems, the young cabbage leaves and the young wheat stems treated with the above-mentioned liquid medicine onto the plate respectively, changing every 12 hours, culturing overnight in an incubator at 25° C., recording the number of aphids killed, and calculating the mortality rates of aphids at different dilution ratios.

$$The mortality rate = \frac{the number of aphids killed}{the number of aphids for testing} \times 100 \%$$

Measuring the mortality rates of the aphids: After the aphids are treated overnight, touching the aphids with a brush head, and if the aphid does not move, it is regarded as dead. Count and record the number of dead aphids. It can be seen from the implementation data results in Table 2 that the iturins have a good control effect on Homoptera insects.

TABLE 2
Control effect of the iturins on Homoptera insects

| | Mortality rate (%) | | | |
|---|---|---|---|---|
| | Aphis | | | |
| Processing | craccivora | Aphis | Brevicoryne | Macrosiphum |
| group | Koch | gossypii | brassicae | avenae |
| CK | 2.67 | 2.00 | 1.33 | 1.33 |
| 5 μg/mL | 76.00 | 72.00 | 69.33 | 69.33 |
| 10 μg/mL | 85.33 | 88.00 | 81.33 | 84.00 |
| 20 μg/mL | 93.33 | 93.33 | 90.00 | 90.67 |

Embodiment 3

Insecticidal Effects of the Iturins on Coleoptera Insects

Dissolving the iturins in methanol to prepare 200 μg/mL mother liquor, and then diluting the mother liquor with water to prepare 5 μg/mL, 10 μg/mL and 20 μg/mL liquid medicine, using the liquid medicine to prepare medicine soil, with the mass ratio of the liquid medicine to soil 1:5, and using medicine soil prepared with clean water treatment as a control; using chopped peanuts as food,using plastic buckets with a capacity of 4 L as containers, and placing 2 L of evenly mixed medicinal soil in each bucket, and adding a proper amount of equal food to mix well; adopting a medicinal soil method, selecting the grubs of the third instar larvae of Protaetia brevitarsis, Holotrichia parallela, Anomala corpulenta and Polyphylla gracilicornis with the same size, and keeping them in the environment with relative humidity of 50% - 70% and temperature of 25° C.-28° C. for 24 hours; treating 15 third instar larvaes with the different medicine soil prepared above respectively, repeating for 3 times; after inoculating the larvaes, culturing them indoors at normal atmospheric temperature, and counting the mortality rate after 56 hours, as shown in Table 3.

TABLE 3
Killing effects of the iturins on different Coleoptera larvaes

| | Mortality rate (%) | | | |
|---|---|---|---|---|
| Processing | Protaetia | Holotrichia | Anomala | Polyphylla |
| group | brevitarsis | parallela | corpulenta | gracilicornis |
| CK | 0.00 | 0.00 | 0.00 | 0.00 |
| 5 μg/mL | 62.22 | 55.56 | 60.00 | 60.00 |
| 10 μg/mL | 82.22 | 80.00 | 82.22 | 80.00 |
| 20 μg/mL | 88.89 | 91.11 | 88.89 | 86.67 |

Embodiment 4

Dissolving the iturins in methanol to prepare 200 μg/mL mother liquor, and then diluting the mother liquor with water into 0.1 μg/mL, 0.5 μg/mL, 1 μg/mL, 5 μg/mL, 10 μg/mL, 20 μg/mL, 50 μg/mL and 100 μg/mL liquid medicine to soak peanuts, and using peanuts that soaking in clean water as a control; using plastic buckets with a capacity of 4 L as containers, and placing 2 L of evenly mixed soil in each bucket, and adding 50 treated peanuts to mix well. Selecting the grubs of the third instar larvae of Holotrichia parallela with the same size, and keeping them in the environment with relative humidity of 50%-70% and temperature of 25° C.-28° C. for 24 hours, repeating the treatment for 3 times. The number of each test insect in each treatment is 15, repeating the treatment for 3 times. After inoculating the larvaes, culturing them indoors at normal atmospheric temperature, and counting the mortality rate of the larvaes and intactness rate of the peanuts after 56 hours, as shown in Table 4.

TABLE 4
Insecticidal and protective effects of iturins on seeds

| Processing | Mortality rate | Peanut intactness |
|---|---|---|
| group | (%) | rate (%) |
| CK | 0.00 | 8 |
| 0.1 μg/mL | 44.44 | 46.00 |
| 0.5 μg/mL | 55.56 | 50.67 |
| 1 μg/mL | 57.78 | 54.67 |
| 5 μg/mL | 62.22 | 60.00 |
| 10 μg/mL | 82.22 | 71.33 |
| 20 μg/mL | 91.11 | 74.00 |
| 50 μg/mL | 97.78 | 76.67 |
| 100 μg/mL | 100.00 | 78.67 |

The above are only preferred embodiments of the present application, and are not intended to limit the present application. On the premise of not departing from the design spirit of the present application, all kinds of modifications and improvements made by ordinary technicians in the field to the technical schemes of the present application should fall in the scope of protection defined by the claims of the present application.

What is claimed is:

1. An application of iturin family lipopeptides as active ingredients in pest control.

2. The application according to claim 1, wherein the iturin family lipopeptides are one of iturin A, iturin B, iturin C, iturin D, iturin E,bacillomycin D, bacillomycin F, bacillomycin L and mycosubtilin, or more than one of iturin A, iturin B, iturin C, iturin D, iturin E,bacillomycin D, bacillomycin F, bacillomycin L and mycosubtilin as a mixture.

3. The application according to claim 1, wherein the pests are Homoptera insects or Coleoptera insects.

4. The application according to claim 3, wherein the Homoptera insects are one or more of Aphis craccivora Koch, Aphis gossypii, Brevicoryne brassicae and Macrosiphum avenae.

5. The application according to claim 3, wherein the Coleoptera insects are one or more of Protaetia brevitarsis, Holotrichia parallela, Anomala corpulenta and Polyphylla gracilicornis.

6. The application according to claim 1, wherein the application is to prepare the iturin family lipopeptides into liquid medicine and then treat plants or soil to control pests.

7. A method for protecting seeds and later-formed plant organs from pests, comprising treating seeds with the iturin family lipopeptides according to claim 1.

8. The method according to claim 7, wherein a mass concentration of the iturin family lipopeptides is 0.01-100 μg/milliliter (ml.).

9. The method according to claim 7, wherein the seeds are coated with a coating agent containing the iturin family lipopeptides.

10. The method according to claim 9, wherein the coating agent further comprises a film forming agent or an adhesive.

11. A method of controlling pets, the method comprising an application of an iturin family lipopeptides.

12. The method of claim 11, wherein the iturin family lipopeptides are selected from a group consisting of: iturin A; iturin B; iturin C; iturin D; iturin E; bacillomycin D; bacillomycin F; bacillomycin L; and mycosubtilin.

13. The method of claim 11, wherein the iturin family lipopeptides are selected from a mixture consisting of or more than one of: iturin A; iturin B; iturin C; iturin D; iturin E; bacillomycin D; bacillomycin F; bacillomycin L; and mycosubtilin.

14. The method of claim 11, wherein the pests are Homoptera insects or Coleoptera insects.

15. The method of claim 14, wherein the Homoptera insects are one or more of Aphis craccivora Koch, Aphis gossypii, Brevicoryne brassicae and Macrosiphum avenae.

16. The method of claim 14, wherein the Coleoptera insects are selected from a group consisting of: Protaetia brevitarsis; Holotrichia parallela; Anomala corpulenta; and Polyphylla gracilicornis.

17. The method of claim 11, wherein the iturin family lipopeptides comprises a liquid medicine and applied to sees, plants or soil.

18. The method of claim 17, wherein the liquid medicine has a mass concentration of the iturin family lipopeptides of 0.01-100 μg/milliliter (ml.).

19. The method of claim 11, wherein the iturin family lipopeptides further comprises a coating agent, a film forming agent or an adhesive.
